(19) United States
(12) Patent Application Publication
(10) Pub. No.: US 2025/0364838 A1
(43) Pub. Date: Nov. 27, 2025

(54) WIRELESS POWER RECEIVING DEVICE AND OPERATING METHOD THEREOF

(71) Applicant: LG ELECTRONICS INC., Seoul (KR)

(72) Inventors: Jinhaeng JANG, Seoul (KR); Seunghun BAEK, Seoul (KR)

(73) Assignee: LG ELECTRONICS INC., Seoul (KR)

(21) Appl. No.: 19/172,891

(22) Filed: Apr. 8, 2025

(30) Foreign Application Priority Data
May 22, 2024 (WO) PCT/KR2024/006934

(51) Int. Cl. H02J 50/10; H02J 7/00; H02J 9/00

(52) U.S. Cl. CPC H02J 50/10; H02J 7/00032; H02J 7/00712; H02J 9/005

(57) ABSTRACT

A wireless power receiving device according to an embodiment of present disclosure, may comprise a battery; a wireless power receiving circuit configured to, wirelessly, receive power from a wireless power transmitting device and charge the battery with the received power; and a processor configured to transmit an operation-off signal to the wireless power transmitting device to turn off an operation of the wireless power transmitting device when a power mode of the wireless power receiving device is a standby mode and a charge amount of the battery exceeds a reference charge amount.

### CROSS-REFERENCE TO RELATED APPLICATION

Pursuant to 35 U.S.C. § 119, this application claims the benefit of an earlier filing date and right of priority to International Application No. PCT/KR2024/006934, filed on May 22, 2024, the contents of which are hereby incorporated by reference herein in its entirety.

### BACKGROUND OF THE INVENTION

### 1. Field of the Invention

The present disclosure relates to a wireless power receiving device, and more specifically, to a wireless power receiving device capable of reducing standby power.

### 2. Discussion of the Related Art

Digital TV service using wired or wireless communication network is becoming popular. Digital TV services may provide a variety of services that cannot be provided by existing analog broadcasting service.

For example, IPTV (Internet Protocol Television) and smart TV service, which are type of digital TV service, provide interactivity that allows users to actively select the type of program to watch and the viewing time. IPTV and smart TV service may provide various additional services, such as Internet search, home shopping, and online games, based on this interactivity.

Recent TV is equipped with battery, and the battery may be charged with power received wirelessly from a wireless power transmitting device.

In order to switch the TV from standby mode to power-on mode, power must be supplied to the standby circuit. When the TV is in the standby mode, a certain amount of power is always supplied to the TV from the adapter through the wireless power transmitting circuit.

When the TV is in the standby mode, an average power consumed for a certain period of time must be below a standard power.

However, due to a power loss of the adapter that occurs in the process of converting Alternating Current (AC) power to Direct Current (DC) power and a power loss due to the operation of the wireless power circuit connected to the back end of the adapter, a problem of the standby power exceeding the standard power (for example, 0.5W) may occur.

### SUMMARY OF THE INVENTION

The purpose of the present disclosure may be to reduce the standby power in a display device that receives power wirelessly to satisfy standard specification of the standby power.

The purpose of the present disclosure may be to provide a display device equipped with a wireless charging system to improve customer convenience on a movement of a portable TV.

The purpose of the present disclosure may be to reduce power loss occurring during wireless power transmission process by supplying power to a standby circuit using a battery provided in a display device.

A wireless power receiving device according to an embodiment of present disclosure, may comprise a battery; a wireless power receiving circuit configured to, wirelessly, receive power from a wireless power transmitting device and charge the battery with the received power; and a processor configured to transmit an operation-off signal to the wireless power transmitting device to turn off an operation of the wireless power transmitting device when a power mode of the wireless power receiving device is a standby mode and a charge amount of the battery exceeds a reference charge amount.

According to an embodiment of the present disclosure, the standby power required under the standby mode of the TV may satisfy the standard power.

According to an embodiment of the present disclosure, the power loss occurring during the wireless power transmission process may be greatly reduced by supplying power to the standby circuit using a battery provided in the display device.

### BRIEF DESCRIPTION OF THE DRAWINGS

FIG. 1 is a block diagram showing a configuration of a display device according to an embodiment of the present disclosure.

FIG. 2 is a diagram illustrating the configuration of a wireless power system according to an embodiment of the present disclosure.

FIG. 3A is a diagram illustrating the detailed configuration of a wireless power system according to an embodiment of the present disclosure, and FIG. 3B is a diagram illustrating the configuration of a wireless power system including a detachable type wireless power transmitting device according to an embodiment of the present disclosure.

FIG. 4 is a flowchart illustrating a method of operating a wireless power receiving device according to an embodiment of the present disclosure.

FIG. 5 is a diagram illustrating the configuration of a standby circuit according to an embodiment of the present disclosure.

FIG. 6A is a diagram illustrating a process for transmitting a power control signal through conventional in-band communication, and FIG. 6B is a diagram illustrating a problem that occurs when transmitting a power control signal through in-band communication.

### DETAILED DESCRIPTION OF THE PREFERRED EMBODIMENTS

Hereinafter, embodiments of the present disclosure will be described in detail with reference to the drawings. The suffixes “module” and “unit or portion” for components used in the following description are merely provided only for facilitation of preparing this specification, and thus they are not granted a specific meaning or function.

The display device according to an embodiment of the present disclosure is, for example, an intelligent display device in which a computer support function is added to a broadcast reception function, and is faithful to a broadcast reception function and has an Internet function added thereto, such as a handwritten input device, a touch screen Alternatively, a more user-friendly interface such as a spatial remote control may be provided. In addition, it is connected to the Internet and a computer with the support of a wired or wireless Internet function, so that functions such as e-mail, web browsing, banking, or games may also be performed. A standardized general-purpose OS may be used for these various functions.

Accordingly, in the display device described in the present disclosure, various user-friendly functions may be performed because various applications may be freely added or deleted, for example, on a general-purpose OS kernel. More specifically, the display device may be, for example, a network TV, HBBTV, smart TV, LED TV, OLED TV, and the like, and may be applied to a smart phone in some cases.

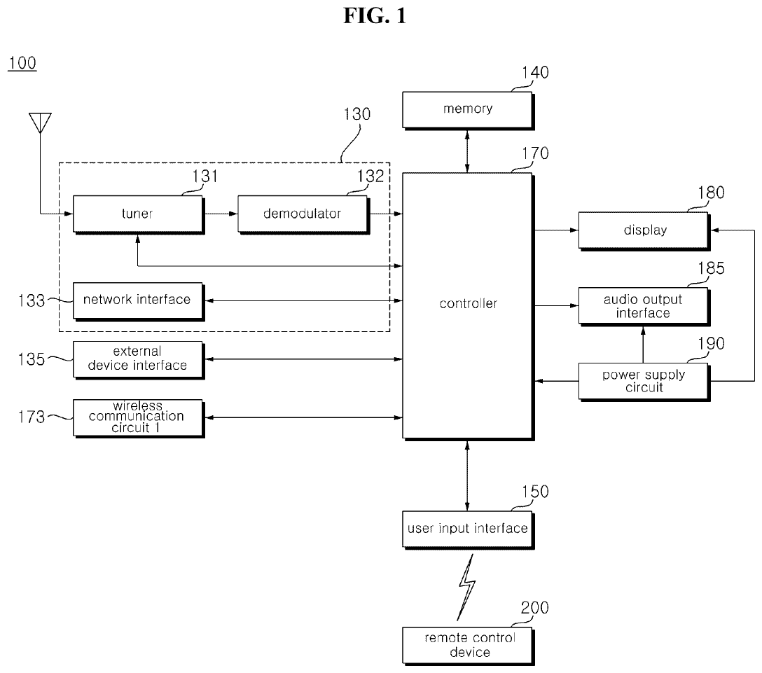

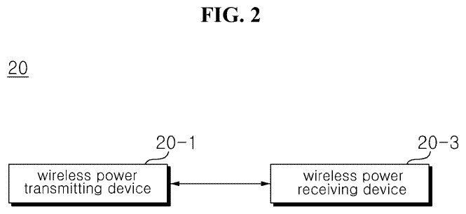

FIG. 1 is a block diagram showing a configuration of a display device according to an embodiment of the present disclosure.

Referring to FIG. 1, a display device 100 may include a broadcast receiver 130, an external device interface 135, a memory 140, a user input interface 150, a controller 170, a wireless communication interface 173, a display 180, a speaker 185, and a power supply circuit 190.

The broadcast receiving unit 130 may include a tuner 131, a demodulator 132, and a network interface 133.

The tuner 131 may select a specific broadcast channel according to a channel selection command. The tuner 131 may receive a broadcast signal for the selected specific broadcast channel.

The demodulator 132 may separate the received broadcast signal into an image signal, an audio signal, and a data signal related to a broadcast program, and restore the separated image signal, audio signal, and data signal to a format capable of being output.

The external device interface 135 may receive an application or a list of applications in an external device adjacent thereto, and transmit the same to the controller 170 or the memory 140.

The external device interface 135 may provide a connection path between the display device 100 and an external device. The external device interface 135 may receive one or more of images and audio output from an external device connected to the display device 100 in a wired or wireless manner, and transmit the same to the controller 170. The external device interface 135 may include a plurality of external input terminals. The plurality of external input terminals may include an RGB terminal, one or more High Definition Multimedia Interface (HDMI) terminals, and a component terminal.

The image signal of the external device input through the external device interface unit 135 may be output through the display 180. The audio signal of the external device input through the external device interface 135 may be output through the speaker 185.

The external device connectable to the external device interface 135 may be any one of a set-top box, a Blu-ray player, a DVD player, a game machine, a sound bar, a smartphone, a PC, a USB memory, and a home theater, but this is only an example.

The network interface 133 may provide an interface for connecting the display device 100 to a wired/wireless network including an Internet network. The network interface 133 may transmit or receive data to or from other users or other electronic devices through a connected network or another network linked to the connected network.

In addition, a part of content data stored in the display device 100 may be transmitted to a selected user among a selected user or a selected electronic device among other users or other electronic devices registered in advance in the display device 100.

The network interface 133 may access a predetermined web page through the connected network or the other network linked to the connected network. That is, it is possible to access a predetermined web page through a network, and transmit or receive data to or from a corresponding server.

In addition, the network interface 133 may receive content or data provided by a content provider or a network operator. That is, the network interface 133 may receive content such as movies, advertisements, games, VOD, and broadcast signals and information related thereto provided from a content provider or a network provider through a network.

In addition, the network interface 133 may receive update information and update files of firmware provided by the network operator, and may transmit data to an Internet or content provider or a network operator.

The network interface 133 may select and receive a desired application from among applications that are open to the public through a network.

The memory 140 may store programs for signal processing and control of the controller 170, and may store images, audio, or data signals, which have been subjected to signal-processed.

In addition, the memory 140 may perform a function for temporarily storing images, audio, or data signals input from an external device interface 135 or the network interface 133, and store information on a predetermined image through a channel storage function.

The memory 140 may store an application or a list of applications input from the external device interface 135 or the network interface 133.

The display device 100 may play back a content file (a moving image file, a still image file, a music file, a document file, an application file, or the like) stored in the memory 140 and provide the same to the user.

The user input interface 150 may transmit a signal input by the user to the controller 170 or a signal from the controller 170 to the user. For example, the user input interface 150 may receive and process a control signal such as power on/off, channel selection, screen settings, and the like from the remote control device 200 in accordance with various communication methods, such as a Bluetooth communication method, a WB (Ultra Wideband) communication method, a ZigBee communication method, an RF (Radio Frequency) communication method, or an infrared (IR) communication method or may perform processing to transmit the control signal from the controller 170 to the remote control device 200.

In addition, the user input interface 150 may transmit a control signal input from a local key (not shown) such as a power key, a channel key, a volume key, and a setting value to the controller 170.

The image signal image-processed by the controller 170 may be input to the display 180 and displayed as an image corresponding to a corresponding image signal. Also, the image signal image-processed by the controller 170 may be input to an external output device through the external device interface 135.

The audio signal processed by the controller 170 may be output to the speaker 185. Also, the audio signal processed by the controller 170 may be input to the external output device through the external device interface 135.

In addition, the controller 170 may control the overall operation of the display device 100.

In addition, the controller 170 may control the display device 100 by a user command input through the user input interface 150 or an internal program and connect to a network to download an application a list of applications or applications desired by the user to the display device 100.

The controller 170 may allow the channel information or the like selected by the user to be output through the display 180 or the speaker 185 along with the processed image or audio signal.

In addition, the controller 170 may output an image signal or an audio signal through the display 180 or the speaker 185, according to a command for playing back an image of an external device through the user input interface 150, the image signal or the audio signal being input from an external device, for example, a camera or a camcorder, through the external device interface 135.

Meanwhile, the controller 170 may allow the display 180 to display an image, for example, allow a broadcast image which is input through the tuner 131 or an external input image which is input through the external device interface 135, an image which is input through the network interface unit or an image which is stored in the memory 140 to be displayed on the display 180. In this case, an image being displayed on the display 180 may be a still image or a moving image, and may be a 2D image or a 3D image.

In addition, the controller 170 may allow content stored in the display device 100, received broadcast content, or external input content input from the outside to be played back, and the content may have various forms such as a broadcast image, an external input image, an audio file, still images, accessed web screens, and document files.

The wireless communication interface 173 may communicate with an external device through wired or wireless communication. The wireless communication interface 173 may perform short range communication with an external device. To this end, the wireless communication interface 173 may support short range communication using at least one of Bluetooth™, Radio Frequency Identification (RFID), Infrared Data Association (IrDA), Ultra Wideband (UWB), ZigBee, Near Field Communication (NFC), Wi-Fi (Wireless-Fidelity), Wi-Fi (Wireless-Fidelity), Wi-Fi Direct, and Wireless USB (Wireless Universal Serial Bus) technologies. The wireless communication interface 173 may support wireless communication between the display device 100 and a wireless communication system, between the display device 100 and another display device 100, or between the display device 100 and a network in which the display device 100 (or an external server) is located through wireless area networks. The wireless area networks may be wireless personal area networks.

Here, the another display device 100 may be a wearable device (e.g., a smartwatch, smart glasses or a head mounted display (HMD), a mobile terminal such as a smart phone, which is able to exchange data (or interwork) with the display device 100 according to the present disclosure. The wireless communication interface 173 may detect (or recognize) a wearable device capable of communication around the display device 100.

Furthermore, when the detected wearable device is an authenticated device to communicate with the display device 100 according to the present disclosure, the controller 170 may transmit at least a portion of data processed by the display device 100 to the wearable device through the wireless communication interface 173. Therefore, a user of the wearable device may use data processed by the display device 100 through the wearable device.

The display 180 may convert image signals, data signals, and OSD signals processed by the controller 170, or image signals or data signals received from the external device interface 135 into R, G, and B signals, and generate drive signals.

Meanwhile, since the display device 100 shown in FIG. 1 is only an embodiment of the present disclosure, some of the illustrated components may be integrated, added, or omitted depending on the specification of the display device 100 that is actually implemented.

That is, two or more components may be combined into one component, or one component may be divided into two or more components as necessary. In addition, a function performed in each block is for describing an embodiment of the present disclosure, and its specific operation or device does not limit the scope of the present disclosure.

According to another embodiment of the present disclosure, unlike the display device 100 shown in FIG. 1, the display device 100 may receive an image through the network interface 133 or the external device interface 135 without a tuner 131 and a demodulator 132 and play back the same.

For example, the display device 100 may be divided into an image processing device, such as a set-top box, for receiving broadcast signals or content according to various network services, and a content playback device that plays back content input from the image processing device.

In this case, an operation method of the display device according to an embodiment of the present disclosure will be described below may be implemented by not only the display device 100 as described with reference to FIG. 1 and but also one of an image processing device such as the separated set-top box and a content playback device including the display 180 the speaker 185.

FIG. 2 is a diagram illustrating the configuration of a wireless power system according to an embodiment of the present disclosure.

Referring to FIG. 2, the wireless power system 20 according to an embodiment of the present disclosure may include a wireless power transmitting device 20-1 and a wireless power receiving device 20-3.

The wireless power transmitting device 20-1 may wirelessly transmit power to the wireless power receiving device 20-3 based on power received from an external power source.

The wireless power transmitting device 20-1 may wirelessly transmit power to the wireless power receiving device 20-3 using either a magnetic induction method or a magnetic resonance method.

The wireless power transmitting device 20-1 may have a portable structure and may have a structure that is detachable from the wireless power receiving device 20-3.

The wireless power receiving device 20-3 may wirelessly receive power from the wireless power transmitting device 20-1.

The wireless power receiving device 20-3 may be provided in the display device 100 of FIG. 1.

The wireless power receiving device 20-3 may be included in the power supply circuit 190 of FIG. 1.

The wireless power receiving device 20-3 may charge the battery by supplying wirelessly received power to a battery provided internally or externally.

Hereinafter, DC (dc) power may be a term that may be replaced by DC voltage or DC, and AC (ac) power may be a term that may be replaced by alternating voltage or AC.

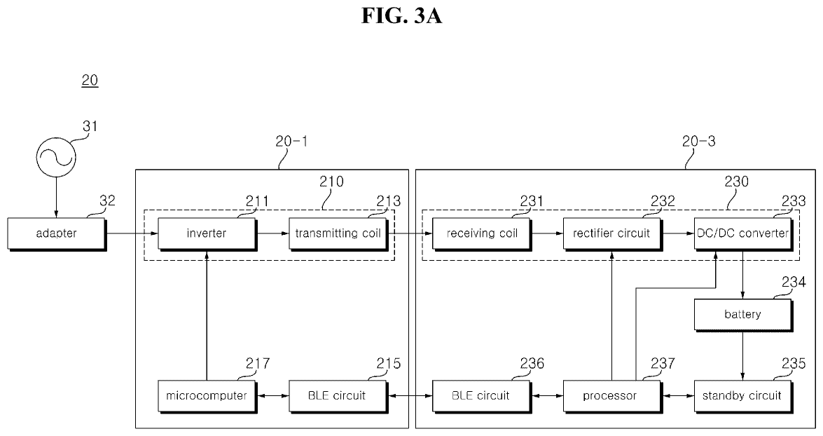

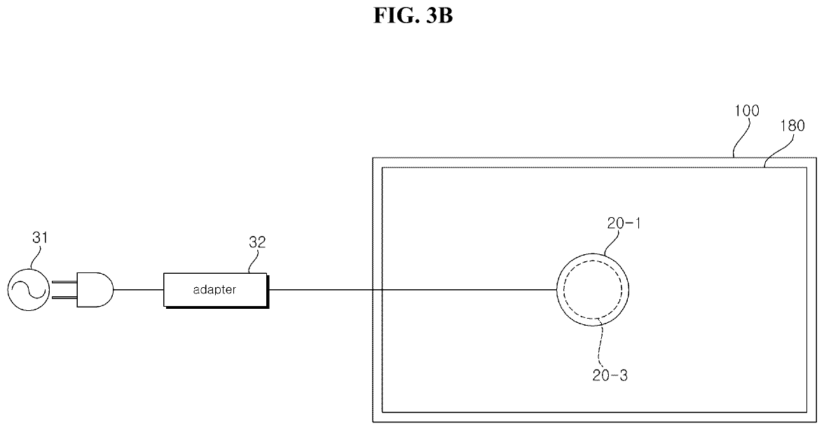

FIG. 3A is a diagram illustrating the detailed configuration of a wireless power system according to an embodiment of the present disclosure, and FIG. 3B is a diagram illustrating the configuration of a wireless power system including a detachable type wireless power transmitting device according to an embodiment of the present disclosure.

The wireless power transmitting device 20-1 may include an inverter 211, a transmitting coil 213, a Bluetooth Low Energy circuit 215, and a microcomputer (or micom 217).

The inverter 211 may receive DC power from the adapter 32. The adapter 32 equipped with a rectifier may convert AC power received from an AC power source 31 into DC power and supply the converted DC power to the inverter 211. For example, the adapter 32 may supply a DC voltage of 20V to the inverter 211.

When connected to the AC power source 31 through a plug, the adapter 32 may convert AC power received from the AC power source 31 into DC power.

The inverter 211 may convert the DC power supplied from the adapter 32 into AC power. The inverter 211 may apply AC current to the transmitting coil 213. The inverter 211 may generate AC power with a frequency of 128 KHz.

The inverter 211 may include a plurality of switching elements for converting DC power to AC power. Each switching element may be either a Metal Oxide Semiconductor Field Effect Transistor (MOSFET) or an Insulated Gate Bipolar Transistor (IGBT).

The transmitting coil 213 may wirelessly transmit power to the receiving coil 231 based on the AC power received from the inverter 211.

The transmitting coil 213 may generate a magnetic field by AC current received from the inverter 211, and transmit the generated magnetic field to the receiving coil 231.

The receiving coil 231 may induce current by the generated magnetic field to generate AC power.

The transmitting coil 213 may wirelessly transmit power to the receiving coil 231 using magnetic induction. When the wireless power transmission method follows the magnetic resonance method, two coils each of the wireless power transmitting circuit 210 and the wireless power receiving circuit 230 are required.

Specifically, under the magnetic resonance method, the wireless power transmitting circuit 210 may include a first transmitting coil and a second transmitting coil, and the wireless power receiving circuit 230 may include a first receiving coil and a second receiving coil. When a current flows in the first transmitting coil and a magnetic field is generated, a current is induced in the second transmitting coil. When a resonance frequency between the second transmitting coil and the first receiving coil match, the magnetic field of the second transmitting coil may be transmitted to the first receiving coil. Due to the magnetic field transmitted to the first receiving coil, a current is induced in the second receiving coil, thereby generating AC power.

Embodiments of the present disclosure will be described assuming a magnetic induction method.

The BLE circuit 215 may communicate with the wireless power receiving device 20-3 according to the BLE standard.

The BLE circuit 215 may communicate with the BLE circuit 236 provided in the wireless power receiving device 20-3.

The BLE circuit 215 may receive one or more of a power control signal or status information of the wireless power receiving device 20-3 from the BLE circuit 236 provided in the wireless power receiving device 20-3.

The power control signal may include either an operation-on signal for turning on the operation of the wireless power transmitting circuit 20-1 or an operation-off signal for turning off the operation of the wireless power transmitting circuit 20-1.

The status information of the wireless power receiving device 20-3 may include one or more of a power consumption of the wireless power receiving device 20-3 or a charging state of the battery 234.

The microcomputer 217 may generally control the operation of the wireless power transmitting device 20-1.

The microcomputer 217 may control an amount of power transmitted to the wireless power receiving device 20-3 based on the power control signal received from the wireless power receiving device 20-3.

The microcomputer 217 may operate the wireless power transmitting circuit 210 only at the moment when a charging voltage of the battery 234 provided in the wireless power receiving device 20-3 is discharged below a reference voltage.

The wireless power receiving device 20-3 may include a receiving coil 231, a rectifier circuit 232, a DC/DC converter 233, a battery 234, a standby circuit 235, a BLE circuit 236, and a processor 237.

The receiving coil 231 may wirelessly receive power from the transmitting coil 213. The receiving coil 231 may generate AC power by inducing a current due to the magnetic field formed by the transmitting coil 213.

The rectifier circuit 232 may rectify the AC power generated by the receiving coil 231 and output DC power.

The DC/DC converter 233 may adjust a magnitude of the DC power output from the rectifier circuit 232 to output it to the battery 234.

The battery 234 may be charged through DC power provided from the DC/DC converter 233.

The standby circuit 235 may be a circuit waiting for user input. The standby circuit 235 may include an IR receiving circuit for receiving an IR signal from the remote control device 200. The standby circuit 235 may further include an LED indicator indicating the power of the wireless power receiving device 20-3 or the power on/off state of the display device 100. The LED indicator may include an LED (Light Emitting Diode).

The standby circuit 235 may be a circuit that stands by for reception of an IR signal under the standby mode of the wireless power receiving device 20-3. Battery 234 may supply power to standby circuit 235.

The standby circuit 235 may be a circuit that waits for an IR signal to control the power of the display device 100.

The BLE circuit 236 may communicate with the BLE circuit 215 of the wireless power transmitting device 20-1.

The processor 237 may generally control the operation of the wireless power receiving device 20-3. The processor 237 may be included in the controller 170 of FIG. 1.

The processor 237 may enter the power mode of the wireless power receiving device 20-3 into the power-on mode.

The processor 237 may determine whether the power mode of the wireless power receiving device 20-3 enters the standby mode.

The processor 237 may turn off the operation of the wireless power receiving circuit 230 when the power mode of the wireless power receiving device 20-3 enters the standby mode.

The processor 237 may transmit an operation-off signal to the wireless power transmitting device 20-1.

The processor 237 may determine whether a charge amount of the battery 234 exceeds a reference charge amount.

If it is determined that the charge amount of the battery 234 is less than or equal to the reference charge amount, the processor 237 may transmit an operation on signal to the wireless power transmitting device 20-1.

The processor 237 may wirelessly receive power from the wireless power transmitting device 20-1 in response to the operation-on signal.

Referring to FIG. 3B, the wireless power transmitting device 20-1 may be attached and detached to one side of the display device 100. The wireless power transmitting device 20-1 may face the wireless power receiving device 20-3 and wirelessly supply power to the wireless power receiving device 20-3.

The wireless power receiving device 20-3 may be built into the display device 100 or may be provided separately from the display device 100. When the wireless power receiving device 20-3 is provided separately from the display device 100, only the battery 234 may be provided in the display device 100. In this case, the wireless power receiving device 20-3 may supply the received power to the connected battery 234.

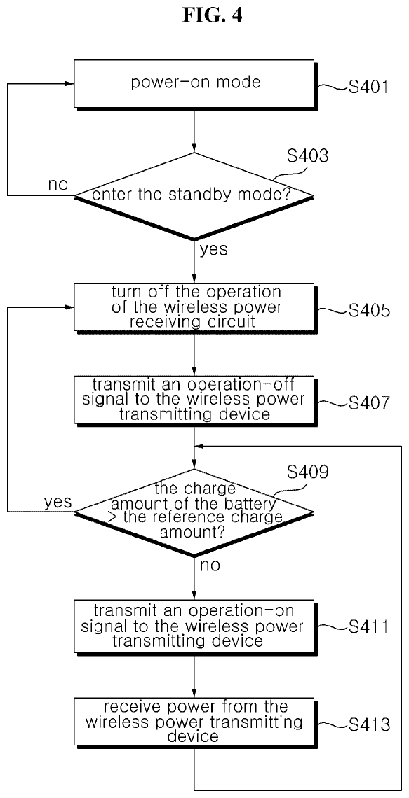

FIG. 4 is a flowchart illustrating a method of operating a wireless power receiving device according to an embodiment of the present disclosure.

The processor 237 of the wireless power receiving device 20-3 may enter the power mode of the wireless power receiving device 20-3 into the power-on mode (S401).

The power mode of the wireless power receiving device 20-3 may include a power-on mode and a standby mode.

The power-on mode may be a mode in which DC power received through the adapter 32 is transmitted to the wireless power receiving circuit 230 via the wireless power transmission circuit 210, supplying power to the battery 234 and components of the wireless power receiving device 20-3 other than the battery 234.

In particular, the power-on mode may be a mode in which power received from the wireless power transmitting device 20-1 is supplied to each of the battery 234 and the standby circuit 235.

The standby mode is a mode for minimizing power consumption and may be a mode in which power received from the wireless power transmitting device 20-1 is supplied only to the standby circuit 235.

The processor 237 may determine whether the power mode of the wireless power receiving device 20-3 enters the standby mode (S403).

In one embodiment, when the processor 237 receives a power-off command to turn off the display device 100 from the remote control device 200, the processor 237 may change the power mode of the wireless power receiving device 20-3 from the power-on mode to the standby mode. That is, the processor 237 may enter the power mode of the wireless power receiving device 20-3 into standby mode upon receiving the power-off command from the remote control device 200.

When the power mode of the wireless power receiving device 20-3 enters the standby mode, the processor 237 may turn off the operation of the wireless power receiving circuit 230 (S405).

When the power mode of the wireless power receiving device 20-3 enters the standby mode, the processor 237 may turn off one or more components included in the wireless power receiving circuit 230.

For example, the processor 237 may turn off the DC/DC converter 233 when the power mode of the wireless power receiving device 20-3 enters the standby mode. When the power mode of the wireless power receiving device 20-3 enters the standby mode, the processor 237 may turn off switching elements included in the DC/DC converter 233.

As the switching elements included in the DC/DC converter 233 are turned off, the consumption of power generated by the switching operation may be prevented.

The processor 237 may transmit an operation-off signal to the wireless power transmitting device 20-1 (S407).

When the power mode of the wireless power receiving device 20-3 enters the standby mode, the processor 237 may may transmit an operation-off signal to the wireless power transmitting device 20-1 to turn off the operation of the wireless power transmitting device 20-1 simultaneously with turning off the operation of the wireless power receiving circuit 230.

The operation-off signal may be a signal for turning off the operation of switching elements included in the inverter 211 included in the wireless power transmitting device 20-1.

The processor 237 may transmit the operation-off signal to the BLE circuit 215 of the wireless power receiving device 20-1 through the BLE circuit 236 of the wireless power transmitting device 20-3.

That is, the processor 237 may transmit the operation-off signal to the wireless power transmitting device 20-1 through the BLE standard.

Conventionally, the power control signal was transmitted to the wireless power transmitting device 20-1 through in-band communication, but in an embodiment of the present disclosure, the power control signal may be transmitted through the BLE standard. This will be described later.

Meanwhile, the processor 237 may transmit the operation-off signal to the wireless power transmitting device 20-1 through the BLE circuit 236 and then turn off the operation of the BLE circuit 236. Accordingly, a power consumed due to activation of the BLE circuit 236 in standby mode may also be reduced.

The processor 237 may determine whether the charge amount of the battery 234 exceeds a reference charge amount (S409).

The charge amount of the battery 234 may be expressed as any one of a charging voltage, a charging current, or a state of charge (SOC) of the battery 234. For example, the reference charge amount may be 20V, but this is only an example.

The processor 237 may monitor the charge amount of the battery 234. The processor 237 may generate a power control signal for power control of the wireless power transmitting device 20-1 based on the monitored charge amount of the battery 234.

If the monitored charge amount of the battery 234 is below the reference charge amount, the processor 237 may generate the power control signal that causes the charge amount of the battery 234 to exceed the reference charge amount.

When the charge amount of the battery 234 exceeds the reference charge amount, the processor 237 may maintain the operation of the wireless power receiving circuit 230 to be turned off (S405). Additionally, since the operation-off signal has already been transmitted to the wireless power transmitting device 20-1, the wireless transmission circuit 210 may also be in an operation-off state.

Accordingly, the adapter 32 does not need to convert AC power to DC power, and losses due to power conversion of the adapter 32 are eliminated.

The microcomputer 217 may transmit a conversion off signal to the adapter 32 according to the operation off signal received from the processor 237. The conversion off signal may be a signal that turns off the function of the adapter 32 that converts AC power to DC power. The processor 237 may include the conversion off signal in the operation off signal, or may separately transmit the conversion off signal to the microcomputer 217.

When the charge amount of the battery 234 exceeds the reference charge amount, operations of the adapter 32, the wireless power transmitting circuit 210, and the wireless power receiving circuit 230 may be turned off.

Accordingly, the loss due to the power conversion of the adapter 32, the loss due to the power conversion of the inverter 211, the loss due to the power conversion of the rectifier circuit 232, and the loss due to the power conversion of the DC/DC converter 233 may be reduced.

In addition, the switching operation of the inverter 211 provided in the wireless power transmitting circuit 210 is no longer required, and power loss caused by the switching operation may be reduced.

In this way, according to the embodiment of the present disclosure, the problem of the standby power required under the standby mode of the wireless power receiving device 20-3 exceeding the standard power may be prevented.

Meanwhile, the processor 237 may transmit the operation-off signal to the wireless power transmitting device 20-1 through the BLE circuit 236 and then turn off the BLE circuit 236 to save power. Turning off the BLE circuit 236 may mean blocking the power supplied to the BLE circuit 236, and turning on the BLE circuit 236 may mean supplying power to the BLE circuit 236.

If it is determined that the charge amount of the battery 234 is less than or equal to the reference charge amount, the processor 237 may transmit an operation-on signal to the wireless power transmitting device 20-1 (S411).

When it is determined that the charge of the battery 234 is discharged below the reference charge amount, the processor 237 may transmit an operation-on signal to turn on the operation of the wireless power transmitting device 20-1 to charge the battery 234.

The operation-on signal may be a signal that controls the wireless power transmitting device 20-1 to wirelessly transmit power to the wireless power receiving device 20-1.

The processor 237 may transmit the operation-on signal to the wireless power receiving device 20-1 through the BLE circuit 236. In one embodiment, the processor 237 may convert the BLE circuit 236 from the power-off state to the power-on state and transmit the operation-on signal to the wireless power receiving device 20-1 through the BLE circuit 236. In this process, the processor 237 may turn on the BLE circuit 236 by supplying the power remaining in the battery 234 to the BLE circuit 236.

The microcomputer 217 may turn on the operation of the inverter 211 in response to the received operation-on signal. The microcomputer 217 may turn on the operation of a plurality of switching elements provided in the inverter 211 in response to the operation-on signal.

The inverter 211 may convert DC power received from the adapter 32 into AC power, and transmit the converted AC power to the transmitting coil 213.

The processor 237 may wirelessly receive power from the wireless power transmitting device 20-1 in response to the operation-on signal (S413).

The transmitting coil 213 may wirelessly transmit AC power generated based on AC power received from the inverter 211 to the receiving coil 231.

The rectifier circuit 232 may rectify the AC power received by the receiving coil 231 and output the rectified DC power to the DC/DC converter 233.

The DC/DC converter 233 may convert a magnitude of the DC power rectified in the rectifier circuit 232 and output the converted DC power to the battery 234. The DC/DC converter 233 may adjust the amount of DC power supplied to the battery 234 so as to maintain an output voltage of the battery 234 constant.

The battery 234 may be charged through DC power received from the DC/DC converter 233.

That is, the processor 237 may turn on the operation of the wireless power transmitting circuit 210 and the wireless power receiving circuit 230 only when the charge amount of the battery 234 is less than the reference charge amount in the standby mode.

When the processor 237 determines that the charge amount of the battery 234 exceeds the reference charge amount as the battery 234 is charged (S409), the processor 237 may turn off the operation of the wireless power transmitting circuit 210 and the wireless power receiving circuit 230.

That is, since only the adapter 32, the wireless power transmitting circuit 210, and the wireless power receiving circuit 230 operate when the battery 234 is charged to exceed the reference charge amount, power loss may be significantly reduced compared to a design that operates at all time.

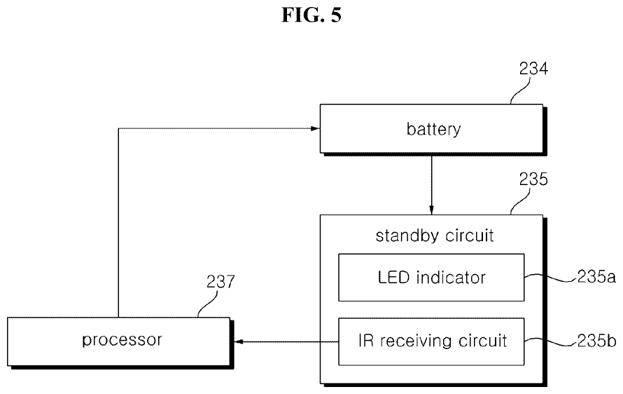

FIG. 5 is a diagram illustrating the configuration of a standby circuit according to an embodiment of the present disclosure.

The standby circuit 235 may include an LED indicator 235a and an IR receiving circuit 235b.

The LED indicator 235a may be an indicator indicating a power status of the display device 100. The LED indicator 235a may output a first color indicating a power-off state of the display device 100 or a second color indicating a power-on state of the display device 100.

The LED indicator 235a may include one or more LEDs. The processor 237 may determine a color to be output by the LED indicator 235a according to the power status.

The IR receiving circuit 235b may be a circuit for receiving an IR signal from the remote control device 200. The IR signal may be a signal for turning on or off the power of the display device 100.

The IR receiving circuit 235b may include an infrared receiving diode capable of detecting an IR signal and a decoder that decodes the detected IR signal into a digital signal.

The battery 234 may supply power to the standby circuit 235 under the standby mode of the display device 100. If the charge amount of the battery 234 exceeds the reference charge amount under the standby mode of the display device 100, the processor 237 may discharge the battery 234 to supply power to the standby circuit 235.

Accordingly, all of the loss due to power conversion of the adapter 32, the loss due to power conversion of the inverter 211, the loss due to power conversion of the rectifier circuit 232, and the loss due to power conversion of the DC/DC converter 233. may be reduced.

That is, the power consumed under the standby mode of the wireless power receiving device 20-3 or the display device 100 is greatly reduced, so that the condition of less than the standard power required in the standby mode may be met.

In one embodiment, the processor 237 may control the discharge of the battery 234 to continuously supply power to the standby circuit 235 when the charge amount of the battery 234 exceeds the reference charge amount in the standby mode. If the charge amount of the battery 234 exceeds the reference charge under standby mode, the processor 237 may control the discharge of the battery 237 to continuously supply power to the standby circuit 235 until the charge amount of the battery 234 reaches the reference charge amount.

In another embodiment, the processor 237 may control the discharge of the battery 234 to periodically supply power to the standby circuit 235 when the charge amount of the battery 234 exceeds the reference charge amount in standby mode. If the charge amount of the battery 234 exceeds the reference charge under the standby mode, the processor 237 control the discharge of the battery 237 to periodically supply power to the standby circuit 235 until the charge amount of the battery 234 reaches the reference charge amount.

When power is periodically supplied to the standby circuit 235 in the standby mode, power consumption may be prevented compared to the case where power is supplied continuously.

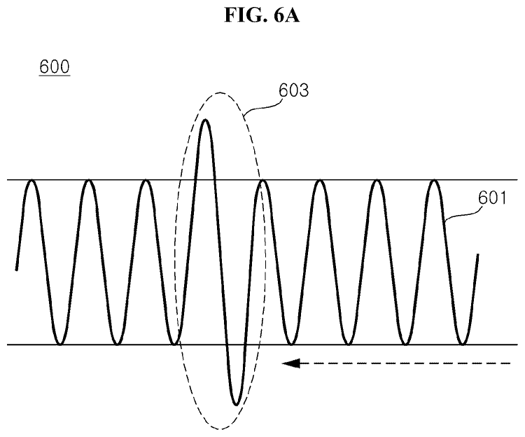

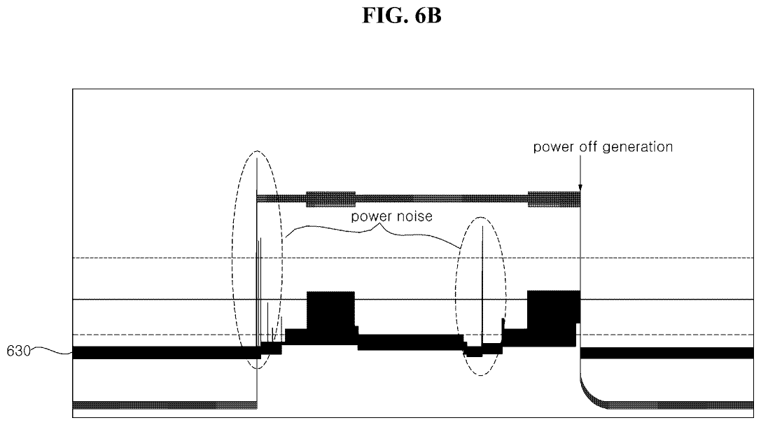

FIG. 6A is a diagram illustrating a process for transmitting a power control signal through conventional in-band communication, and FIG. 6B is a diagram illustrating a problem that occurs when transmitting a power control signal through in-band communication.

In-band communication is a communication method in which data and control signal are transmitted through the same medium.

Referring to FIG. 6A, a conventional wireless power receiving device senses a amount of power received from a wireless power transmitting device. The wireless power receiving device transmit, to the wireless power transmitting device, a modulated voltage signal 600 by embedding a control signal 603 among a signal for representing the sensed amount of power, a signal for representing a feedback amount corresponding to the sensed amount of power, or a signal for controlling an operation of the wireless power transmitting device.

That is, the conventional wireless power receiving device transmitted the modulated voltage signal 600 containing the control signal 603 to the wireless power transmitting device using an ASK (Amplitude Shift Keying) method that modulates the amplitude of the voltage signal.

However, in this process, as shown in FIG. 6B, a power noise is superimposed on the modulated voltage signal 630, causing a problem in which the wireless power transmitting device is turned off due to abnormal operation.

In an embodiment of the present disclosure, the problem of the wireless power transmitting device being turned off due to abnormal operation may be prevented by using a BLE circuit instead of in-band communication.

A wireless power receiving device 20-3 according to an embodiment of present disclosure may comprise a battery 234, a wireless power receiving circuit 230 configured to, wirelessly, receive power from a wireless power transmitting device 20-1 and charge the battery with the received power and a processor 237 configured to transmit an operation-off signal to the wireless power transmitting device 20-1 to turn off an operation of the wireless power transmitting device 20-1 when a power mode of the wireless power receiving device 20-3 is a standby mode and a charge amount of the battery 234 exceeds a reference charge amount.

The wireless power receiving device 20-3 may further comprise a standby circuit 235 configured to wait a reception of a signal for controlling a power status of the wireless power receiving device 20-3, wherein the processor 237 is further configured to, under the standby mode, discharge the battery 234 to supply power to the standby circuit 235 when the charge amount of the battery 234 exceeds the reference charge amount.

The processor 237 may turn off an operation of the wireless power receiving circuit 230 when the charge amount of the battery 234 under the standby mode exceeds the reference charge amount.

The wireless power receiving circuit may comprise a receiving coil 231 configured to, wirelessly, receive an AC power from a transmitting coil 213 provided in the wireless power transmitting device 20-1, a rectifier circuit 232 configured to rectify the AC power received through the receiving coil 231 to output a DC power, and a DC/DC converter 233 configured to adjust a magnitude of the DC power output from the rectifier circuit 232, wherein the processor 237 may turn off an operation of the rectifier circuit 232 and the DC/DC converter 233.

The wireless power transmitting device 20-1 may comprise an inverter 211 configured to convert a DC power received from an adapter 32 into an AC power and the transmitting coil 213, wherein the operation-off signal is a signal for turning off the operation of the inverter 211.

The wireless power receiving device 20-3 may further comprise a low-power Bluetooth (Bluetooth Low Energy, BLE) circuit 236, wherein the processor 237 may transmit the operation-off signal to the wireless power transmitting device 230-1 through the BLE circuit 236.

The processor 237 may further turn off the BLE circuit 236 after transmitting the operation off signal to the wireless power transmitting device 20-1 through the BLE circuit 236.

The processor 237 may turn on the BLE circuit 236 when it is determined that the charge amount of the battery 234 is discharged below the reference charge, and transmit, to the wireless power transmittting device 20-1, an operation-on signal to turn on the operation of the wireless power transmitting device 20-1 through the BLE circuit 236.

The processor 237 may, wirelessly, receive power from the wireless power transmitting device 20-1 in response to the operation-on signal, and charge the battery 234 based on the received power.

The power mode of the wireless power receiving device may comprise a power-on mode in which power is supplied to each of the battery 234 and the standby circuit 235 using power received from the wireless power transmitting device 20-1, and the standby mode that supplies a power to the standby circuit 235 using a power charged in the battery 234.

The processor 237 may turn on the operation of the wireless power transmitting device 20-1 only when it is determined that the charge amount of the battery 234 is discharged below the reference charge amount.

The standby circuit 235 may comprise an LED indicator 235a configured to output the power status of the wireless power receiving device 20-3, and an IR receiving circuit 235b configured to receive an IR signal for controlling the power status.

A display device may comprises the wireless power receiving device 20-1 and a display 180.

According to an embodiment of the present invention, the above-described method may be implemented as processor-readable code on a program-recorded medium. Examples of media that the processor may read include ROM, RAM, CD-ROM, magnetic tape, floppy disk, and optical data storage device.

The display device described above is not limited to the configuration and method of the above-described embodiments, and the embodiments may be configured by selectively combining all or part of each embodiment so that various modifications may be made.

What is claimed is:

1. A wireless power receiving device, comprising:
a battery;
a wireless power receiving circuit configured to wirelessly receive power from a wireless power transmitting device for charging the battery; and
a processor configured to:
transmit an operation-off signal to turn off an operation of the wireless power transmitting device based on a power mode of the wireless power receiving device being in a standby mode and a charge amount of the battery exceeding a threshold charge amount.

2. The wireless power receiving device of claim 1, further comprising a standby circuit configured to receive a signal for controlling a power status of the wireless power receiving device,
wherein the processor is further configured to cause the battery to supply power to the standby circuit in a standby mode based on the charge amount of the battery exceeding the threshold charge amount.

3. The wireless power receiving device of claim 2, wherein the processor is further configured to turn off operation of the wireless power receiving circuit in the standby mode based on the charge amount of the battery exceeding the threshold charge amount.

4. The wireless power receiving device of claim 3, wherein the wireless power receiving circuit comprises:
a receiving coil configured to wirelessly receive AC power from a transmitting coil of the wireless power transmitting device;
a rectifier circuit configured to rectify the received AC power to output DC power; and
a DC/DC converter configured to adjust a magnitude of the DC power output from the rectifier circuit,
wherein the processor is configured to turn off operation of the rectifier circuit and the DC/DC converter.

5. The wireless power receiving device of claim 4, wherein the operation-off signal is a signal for turning off operation of an inverter of the wireless power transmitting device configured to convert DC power received from an adapter to AC power.

6. The wireless power receiving device of claim 5, wherein the operation off signal is further for turning off a conversion function of the adapter.

7. The wireless power receiving device of claim 1, further comprising:
a low-power Bluetooth (Bluetooth Low Energy, BLE) circuit,
wherein the processor is configured to transmit the operation-off signal to the wireless power transmitting device through the BLE circuit.

8. The wireless power receiving device of claim 7, wherein the processor is further configured to turn off the BLE circuit after transmitting the operation-off signal to the wireless power transmitting device through the BLE circuit.

9. The wireless power receiving device of claim 8, wherein the processor is further configured to:
turn on the BLE circuit based on the charge amount of the battery being discharged below the threshold charge amount, and
transmit, to the wireless power transmitting device, an operation-on signal to turn on operation of the wireless power transmitting device through the BLE circuit.

10. The wireless power receiving device of claim 9, wherein the processor is further configured to:
cause the wireless power receiving circuit to wirelessly receive power from the wireless power transmitting device in response to the operation-on signal, and
charge the battery based on the received power.

11. The wireless power receiving device of claim 2, wherein the power mode of the wireless power receiving device comprises:
a power-on mode in which power is supplied to the battery and the standby circuit using power received from the wireless power transmitting device, and
the standby mode in which power is supplied to the standby circuit using power from the battery.

12. The wireless power receiving device of claim 2, wherein power is supplied to the standby circuit periodically.

13. The wireless power receiving device of claim 1, wherein the processor is further configured to cause operation of the wireless power transmitting device to turn on only based on the charge amount of the battery being discharged below the threshold charge amount.

14. The wireless power receiving device of claim 2, wherein the standby circuit comprises:
an LED indicator configured to output the power status of the wireless power receiving device, and
an IR receiving circuit configured to receive an IR signal for controlling the power status.

15. A display device, comprising:
the wireless power receiving device according to claim 1; and
a display.
